(19) United States
(12) Patent Application Publication
(10) Pub. No.: US 2005/0065778 A1
(43) Pub. Date: Mar. 24, 2005

(54) Secure speech

(76) Inventors: Steven J. Mastrianni, Unionville, CT (US); Dennis G. Shea, Ridgefield, CT (US); Ajay Mohindra, Yorktown Heights, NY (US); Thomas E. Chefalas, Somers, NY (US); David F. Bantz, Portland, ME (US); Alexei Karve, Mohegan Lake, NY (US)

Correspondence Address: David Aker, 23 Southern Road, Hartsdale, NY, 10530, US

(21) Appl. No.: 10/669,835

(22) Filed: Sep. 24, 2003

(51) Int. Cl. G10L 19/00

(52) U.S. Cl. 704/200.1

(57) ABSTRACT

A method, apparatus and computer product for masking speech. The system includes a signal acquiring apparatus for generating an electrical signal representative of the speech; a processing apparatus for using the electrical signal to provide an audio signal which cancels the speech; and a signal generator, also referred to as a babble generator, for providing a speech masking signal to mask any speech not canceled. The masking signal is generated by processing the speech in one of several ways so that its content is not intelligible.

### FIELD OF THE INVENTION

The present invention relates to apparatus, methods and computer readable media for providing an environment with secure speech capabilities. More particularly, the invention relates to providing such an environment by using noise canceling and noise covering techniques. The present invention can be deployed on various types of portable devices including, but not limited to phones, PDAs, pagers, and portable computers.

### BACKGROUND OF THE INVENTION

Most business travelers bring work with them on trips to maximize the useful time away from the office, and to give them something to do on an airplane or train. They usually bring along a portable computer of some type so that they can edit or create documents and presentations, or write software. Most of these travelers also carry a cellular phone, and some carry a dictating device such as a tape recorder or digital voice recorder. The recording is used to make notations or to dictate documents for a secretary to transcribe when the traveler returns to the office.

Dictating information in an airplane can be distracting to the other passengers and can also be uncomfortable for the speaker as some of the dictated information may be sensitive. No one wants to sit next to someone that is continually dictating, especially on a late “red-eye” flight. It would be desirable for there to be no noise or distraction while speaking or dictating.

There is a considerable amount of prior art in the fields of noise cancellation and echo cancellation. Some of these methods employ algorithms and technologies to remove background noise, echo effects, and other undesirable content from the desired audio. Although these systems have been developed to remove the noise component from speech, almost none of them have been used to cancel the entire speech audio content.

One approach that does attempt to cancel the speech content is set forth in U.S. Pat. No. 5,526,421 to Berger et al. In Berger et al., a voice transmission system, such as a telephone, includes a microphone in combination with active sound cancellation means comprising a speaker and a signal processor for generating a mirror-image wave form with respect to the signal generated when speaking into the microphone. The mirror-image wave form is used to activate the speaker, thereby canceling the user's voice.

Unfortunately this approach does not necessarily provide the user with complete privacy, since the cancellation is never perfect and does not prevent the user's voice from being overheard by others. This is because the loudspeaker or other sound source which provides the canceling audio is not identical to the original source, and is at a location which is at least slightly displaced therefrom. While the speaker's voice may be at least partially canceled, it is virtually impossible to match frequency, phase and amplitude so as to have complete cancellation in all regions of the space surrounding the speaker. Under these circumstances, there is a large probability that someone in the vicinity of the speaker will be able to hear and understand what the speaker is saying. The result is a lack of complete privacy, and the very purpose of the system is defeated.

### SUMMARY OF THE INVENTION

It is therefore an aspect of the present invention to provide a system and a method for canceling a speaker's voice and masking it, so that complete privacy is assured.

It is another aspect of the invention to provide a masking signal, and apparatus for generating it, that is related to the sounds that are to be masked.

In accordance with the invention, sound is converted into an electrical signal by a microphone and the electrical signal is analyzed. The electrical signal also is converted into another signal that is the exact opposite of the incoming electrical signal. This resulting signal is them digitally modulated, amplified, and sent back by a speaker or speakers mounted in the device, canceling out the audible portion of the sound.

The invention may be implemented by a specialized electronic circuit and associated software algorithms embodied by the specialized circuitry and other programs installed on the device. The circuit may employ techniques and methods normally found in the area of noise reduction. In accordance with the invention, as in some noise reduction applications, the noise component of a particular signal is detected, often using a statistical characterization. The noise component is then removed from the signal, either by introducing an identical noise component having a phase opposite to that of the original, or by some other means. The signal components that are 180 degrees out of phase with each other cancel each other out, removing the noise component.

The present invention provides a similar type of method, but instead of applying it to the noise component, the method is applied to the main voice component. In this case, the person speaking into a microphone causes a signal to be produced. This signal is immediately analyzed, then inverted, and retransmitted using speakers built into the device. The speakers are designed to create an acoustic field that is directed in the same way as the person's voice, except that the field is minimized in the direction of the microphone. Thus the microphone receives the person's voice alone; all other listeners receive both the person's voice and the output of the speakers. Since these are equal in amplitude and opposite in phase, they cancel, so that other listeners hear nothing. The user is then free to dictate or speak into a device without others being able to discern the speaker's content.

The invention employs the phenomenon called “acoustic masking” in recognizing that one sound, if of sufficient amplitude, can make another sound difficult or impossible to hear. Using this phenomenon, the device generates a noise component that disguises or hides the speaker's content. That noise is subtracted from the voice component. The frequency of the noise can also be shifted within the audible range to discourage eavesdropping.

Thus, in accordance with the invention, a method for masking speech, a system having components for masking speech, and an article of manufacture having computer readable program code thereon, the code causing the computer to perform, the method are all provided. The method comprises generating an electrical signal representative of the speech, using the electrical signal to provide an audio signal which cancels the speech; and providing a speech masking signal to mask any speech not canceled. The speech masking signal is supplied by a babble generator. The speech masking signal may be produced by rearranging the speech so that it is not intelligible.

The speech masking signal may be provided by pitch inverting the speech. The pitch may be inverted by low pass filtering the electrical signal representative of the speech to provide a low pass filtered signal; mixing the low pass filtered signal with a carrier frequency to produce an output signal including the carrier frequency and two side bands; and low pass filtering the output signal to produce the masking signal.

The speech masking signal may also be produced reading out digital representations of signals disruptive to the understanding of speech from a memory; and converting the digital representations to the speech masking signal. The digital representations may be in the form of one of pulse code modulation and adaptive pulse code modulation, and may be representative of multiple persons speaking simultaneously. The speech masking signal may be produced by sampling portions of the speech; and providing the portions in reverse order. At least one of amplitude and frequency of the masking signal may be changed at intervals. The intervals may be fixed, variable or random.

The speech masking signal may be produced by sampling portions of the speech; and providing the portions with a predetermined time delay. In this case also, the speech masking signal may be produced by sampling portions of the speech; and providing the portions in reverse order and with a predetermined time delay. Again, at least one of amplitude and frequency of the masking signal may be changed at fixed, variable or random intervals.

The speech masking signal may be produced by sampling portions of the speech; and providing the portions in a random manner. The portions may be provided so as to be random relative to amplitude and frequency of the speech.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a block diagram of a system in accordance with the invention;

FIG. 2 is a block diagram of a first embodiment of a babble generator which may be used in the system of FIG. 1; and

FIG. 3 is a block diagram of a second embodiment of a babble generator which may be used in the system of FIG. 1.

FIG. 4 is a block diagram of a third embodiment of a babble generator which may be used in the system of FIG. 1.

### DESCRIPTION OF THE INVENTION

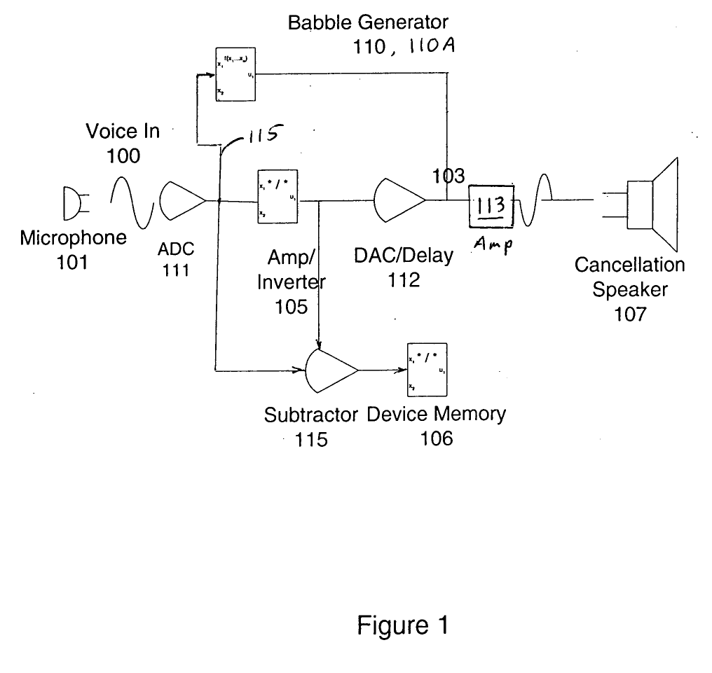

One form of preferred embodiment is a circuit consisting of an amplifier, a analog-to-digital converter, an inverter, a digital-to-analog converter, a power amplifier and two or more speakers. The invention may then be embodied as a computer program (or as computer readable program code stored on a computer readable storage medium) in a computing device that inverts the phase of an incoming signal and uses that inversion to cancel or disguise the sound of the speaker's voice, thus preventing other individuals in the general vicinity of the speaker from hearing clearly what the user is saying. This system can also be implemented using a microphone coupled to an analog-to-digital converter and then to the circuitry described in FIG. 1.

It will be understood that the system of FIG. 1 may be implemented as a stand alone device used with, for example, a telephone, so that the user may have a private telephone conversation with someone at the other end of the telephone without fear of a private conversation being overheard by someone else. However, as noted above, the system and method of the invention may also be used with a device for recording dictation or with a computer. It may be provided as a computer peripheral device. Alternatively, the system may be implemented in a computer, using the computer's sound card for certain functions, and a computer program to perform other functions. The computer may be used to implement the invention, while being connected to a telephone system to allow a private conversation to take place. In this case, as noted above, the system according to the invention is implemented by the computer, rather than a separate stand alone piece of equipment. In addition, the invention may be used when a computer is performing speech recognition tasks, including speech directed navigation and voice transcription.

Referring specifically to FIG. 1, when the user speaks into a microphone 101, the signal 100 is generated by the microphone and its associated support circuitry, including an analog-to digital converter or ADC 111. The signal is routed to a first input of a subtractor 115 to subtract any component of the canceling audio from the normal incoming audio, which is processed by an inverting amplifier Amp/Inverter 105, and applied to a second input of subtractor 115. The resultant audio is routed to the normal audio handling features of a device memory 106. This may be a recording head, memory, disk, or any device used to record, process, or play the input audio signal 100. The input signal 100 is also routed from ADC 111 to amplifier/inverter 105 where the signal is processed and inverted for output. The inverted output signal is then routed to a digital-to-analog converter DAC/Delay 112, then to a power amplifier 113 and then to a speaker or speakers 107 where it is output from the device system. The output signal, being 180 degrees out of phase with the input signal, causes the speaker's voice to be canceled in the general proximity of the user. This assists in prohibiting others from listening in on the user's conversation or dictation, but as noted above, is not always sufficient.

The digital signal at Amp/Inverter 105 may be optionally time shifted a small amount to compensate for latencies in components and software, and is then converted to analog at DAC/Delay 112. The signal is then routed to the cancellation speaker 107.

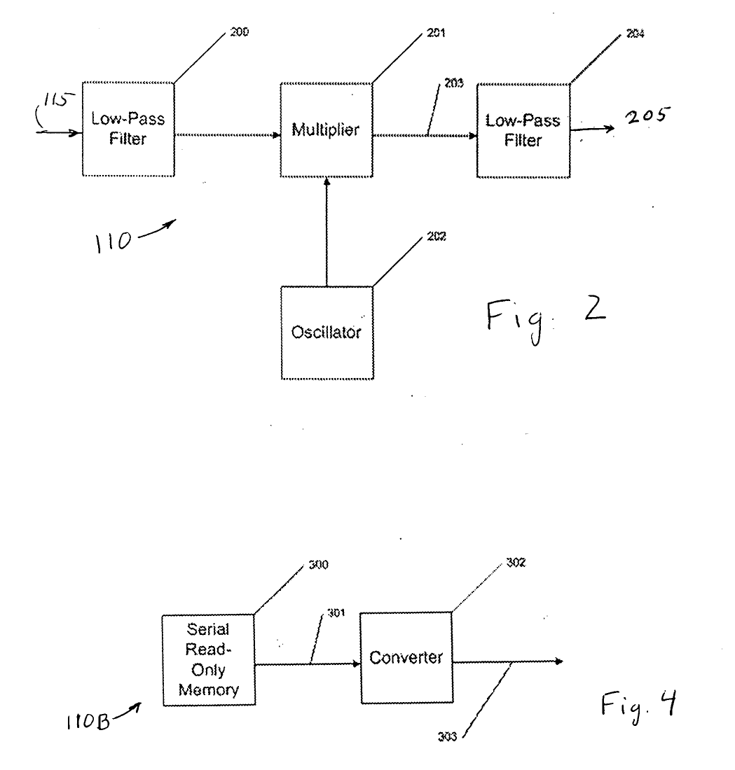

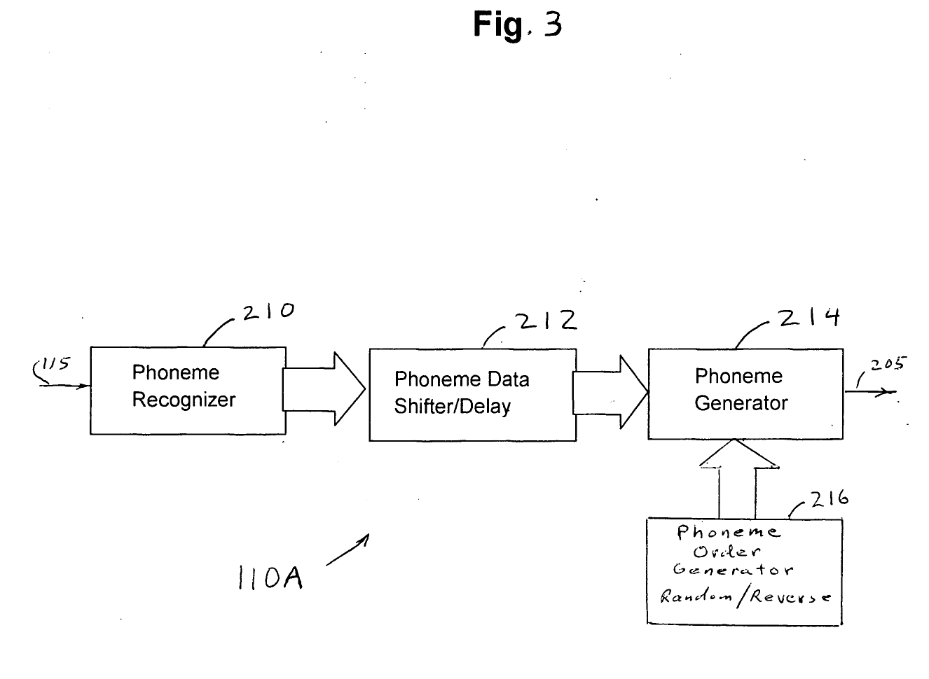

The system in accordance with the present invention also contains a babble generator 110 (FIG. 2), 110A (FIG. 3), or 110B (FIG. 4) which may generate human-like “babble” by, for example, sampling the digital input and sending a random set of digital phonemes which are converted to analog and output through the cancellation speaker. The phonemes may be generated in several ways, as described below.

Referring to FIG. 2, a babble generator 110 receives input from input signal 100 of FIG. 1 along a signal line 115. This form of babble generator is similar to that used for secure analog telephones. It comprises a pitch shifter followed by a filter. The shifter includes a low-pass filter 200, which band-limits the speech signal so that it does not have any frequency components exceeding, for example, 3 kHz. This band-limited signal is input to a multiplier 201 having as another input a 3 kHz signal from a local oscillator 202. The output of multiplexer 201 is a signal on a line 203 containing the input signal 100 shifted to the 3-6 kHz range, the 3 kHz carrier, and a signal that is the input signal 100, pitch-inverted. That is, if the input signal contains a 1 kHz component, the pitch-inverted signal contains a 2 kHz component. If the input signal contains a 2.5 kHz component the pitch-inverted signal contains a 500 Hz component. The output of the multiplier is input into a low-pass filter 204, which is preferably identical to low-pass filter 200. The output of that low-pass filter is a signal on a signal line 205, which is a pitch-inverted version of input signal 100, and is mixed with the output of DAC/delay 112 (FIG. 1) to form the input to power amplifier 113.

Referring to FIG. 3, a babble generator 110A uses phoneme recognition and anti-phoneme generation. This approach relies on the fact that speech can be broken down into several primary types of phonemes called stops, fricatives, affricates, nasals, liquids, and glides. Each category describes a particular sound using a consonant or group of consonants. For example, the sound made with “ch” is fricative or affricate, while the sound made by the “y” is referred to a glide.

In FIG. 3, using a rule-based phoneme recognizer, the incoming text is sampled at the user's input after low pass filtering and converted to phonemes in a phoneme recognizer 210. The conversion of analog voice signals to phonemes is a well understood technology for which there are several different methods available. In the present invention, these methods may be encapsulated in an electrical component or chip, or performed in software. When the phonemes are detected, a shifting or delay may be applied in a phoneme data shifter/delay 212. The output of shifter/delay 212 is applied to a phoneme generator 214. Generator 214 creates a negation to the phoneme, creating a cancelling sound or what may be referred to as an “anti-phoneme”. These “anti-phonemes” are then used as output to be applied to the input of amplifier 113, thus producing a babble content that has the capacity to render the user's speech unintelligible. A phoneme order generator 216 may also be utilised, as described below.

In another form of the present invention, which may utilize a portion of the approach of FIG. 2, the phonemes detected by the phoneme recognizer 210 and subsequently generated by the phoneme generator 214 are shifted up or down in frequency and or amplitude, and may also be delayed a short amount of time prior to being output the speaker. The techniques for shifting frequency or delaying a signal are well understood.

In yet another form of the present invention, the phonemes detected by the phoneme recognizer 210 and subsequently generated by the phoneme generator 214 are randomly replaced or modified using a form of a phoneme order generator 216 that selects at random, or in a reverse order, a phoneme or phonemes, respectively, to substitute for existing phonemes, prior to output to the speaker. If operating in a random mode, the order of the generated phonemes is a random variation of the order of the recognized phonemes. If operating in a reverse order mode, then during a given fixed or random, but relatively short time interval, phonemes are delayed and played back in reverse order. The amplitudes of the phonemes may also be varied in a random manner, at fixed or random intervals. These approaches all serve to further assist in rendering the speech unintelligible.

The embodiments of the babble generators 110 and 110A of FIG. 2 and FIG. 3, respectively, which derive input from the speaker, have a major advantage in that, subject to a very short delay, there are no masking sounds when the speaker is not speaking. This permits the area to be quiet when speech does not need need to be masked. With suitable modifications, such as the addition of a speech level detector and a switching circuit, having a comparator responsive to the speech level, the embodiment of FIG. 4 described below may be modified to operate in a similar manner.

Referring to FIG. 4, a babble generator 110 is not driven by input signal 100. Block 300 comprises a read-only serially-accessible memory containing a digitized version of multiple speakers' speech, as might be recorded at a cocktail party, for example. The output 301 of block 300 is in some convenient representation such as Pulse-Code Modulation (PCM) or Adaptive Digital Pulse-Code Modulation (ADPCM), well-known in the art. This representation is input into a digital-to-analog converter 302 that can decode the representation to reconstruct the speech as originally digitized. Any type of speech can be used, as can other signals not related to speech but known to be disruptive to the understanding of speech. The output of block 302 is signal 303 which is the required babble output, and is mixed with the output of DAC/delay 112 to form the input to power amplifier 113.

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

The present invention can be realized in hardware, software, or a combination of hardware and software. Any kind of computer system, or other apparatus adapted for carrying out the methods and/or functions described herein, is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system, is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

1. A method for masking speech, comprising;
generating an electrical signal representative of the speech;
using said electrical signal to provide an audio signal which cancels the speech; and
providing a speech masking signal to mask any speech not canceled.

2. A method as recited in claim 1, wherein said speech masking signal is supplied by a babble generator.

3. A method as recited in claim 1, wherein said speech masking signal is produced by rearranging the speech so that it is not intelligible.

4. A method as recited in claim 1, wherein said speech masking signal is provided by pitch inverting the speech.

5. A method as recited in claim 4, wherein said pitch inverting is performed by steps comprising:
low pass filtering the electrical signal representative of the speech to provide a low pass filtered signal;
mixing the low pass filtered signal with a carrier frequency to produce an output signal including the carrier frequency and two side bands; and
low pass filtering the output signal to produce the masking signal.

6. A method as recited in claim 1, wherein said speech masking signal is produced by the steps of:
reading out digital representations of signals disruptive to the understanding of speech from a memory; and
converting the digital representations to said speech masking signal.

7. A method as recited in claim 6, wherein said digital representations are in the form of one of pulse code modulation and adaptive pulse code modulation.

8. A method as recited in claim 6, wherein said digital representations are representative of multiple persons speaking simultaneously.

9. A method as recited in claim 1, wherein said speech masking signal is produced by:
sampling portions of the speech; and
providing the portions in reverse order.

10. A method as recited in claim 9, wherein at least one of amplitude and frequency of the masking signal is changed at intervals.

11. A method as recited in claim 10, wherein said intervals are fixed, variable or random.

12. A method as recited in claim 1, wherein said speech masking signal is produced by:
sampling portions of the speech; and
providing the portions with a predetermined time delay.

13. A method as recited in claim 12, wherein at least one of amplitude and frequency of the masking signal is changed at intervals.

14. A method as recited in claim 13, wherein said intervals are fixed, variable or random.

15. A method as recited in claim 1, wherein said speech masking signal is produced by:
sampling portions of the speech; and
providing the portions in reverse order and with a predetermined time delay.

16. A method as recited in claim 15, wherein at least one of amplitude and frequency of the masking signal is changed at intervals.

17. A method as recited in claim 1, wherein said speech masking signal is produced by:
sampling portions of the speech; and
providing the portions in a random manner.

18. A method as recited in claim 17, wherein the portions are provided so as to be random relative to amplitude and frequency of the speech.

19. A method as recited in claim 17, wherein at least one of amplitude and frequency of the masking signal is changed at intervals.

20. A method as recited in claim 1, wherein the masking signal is provided only when speech is present.

21. A system for masking speech, said system comprising:
signal acquiring apparatus for generating an electrical signal representative of the speech;
processing apparatus for using said electrical signal to provide an audio signal which cancels the speech; and
a signal generator for providing a speech masking signal to mask any speech not canceled.

22. A system as recited in claim 21, wherein said speech masking signal generator is a babble generator.

23. A system as recited in claim 21, wherein said signal generator comprises circuity for rearranging the speech so that said speech masking signal is not intelligible.

24. A system as recited in claim 21, wherein said signal generator pitch inverts the speech.

25. A system as recited in claim 24, wherein said signal generator comprises:
a first low pass filter for filtering the electrical signal representative of the speech to provide a low pass filtered signal;
a mixer for mixing the low pass filtered signal with a carrier frequency to produce an output signal including the carrier frequency and two side bands; and
a second low pass filter for low pass filtering the output signal to produce the masking signal.

26. A system as recited in claim 21, wherein said signal generator comprises:
a memory for storing digital representations of signals disruptive to the understanding of speech; and
a converter for converting the digital representations in the memory to said speech masking signal.

27. A system as recited in claim 26, wherein said digital representations in said memory are in the form of one of pulse code modulation and adaptive pulse code modulation.

28. A system as recited in claim 26, wherein said digital representations in said memory are representative of multiple persons speaking simultaneously.

29. A system as recited in claim 21, wherein said signal generator comprises:
a sampler for sampling portions of the speech;
a memory for storing the portions of the speech that are sampled; and
a memory reader for providing the portions in the memory in reverse order.

30. A system as recited in claim 29, further comprising means for changing at least one of amplitude and frequency of the masking signal at intervals.

31. A system as recited in claim 39, further comprising means for changing at least one of amplitude and frequency of the masking signal at intervals that are fixed, variable or random.

32. A system as recited in claim 21, wherein said signal generator comprises:
a sampler for sampling portions of the speech; and
a time delay generator for providing the portions with a predetermined time delay.

33. A system as recited in claim 32, further comprising means for changing at least one of amplitude and frequency of the masking signal at intervals.

34. A system as recited in claim 32, further comprising means for changing at least one of amplitude and frequency of the masking signal at intervals that are fixed, variable or random.

35. A method as recited in claim 21, wherein said signal generator comprises:
a sampler for sampling portions of the speech; and
a reverser for providing the portions in reverse order and with a predetermined time delay.

36. A system as recited in claim 35, further comprising means for changing at least one of amplitude and frequency of the masking signal at intervals.

37. A system as recited in claim 21, wherein said signal generator comprises:
a sampler for sampling portions of the speech; and
a random generator for providing the portions in a random manner.

38. A system as recited in claim 37, wherein the random generator provides the portions so as to be random relative to amplitude and frequency of the speech.

39. A system as recited in claim 38, further comprising means for changing at least one of amplitude and frequency of the masking signal at intervals.

40. A system as recited in claim 21, in combination with a programmed digital computer, the system having an output for providing said electrical signal representative of the speech to said digital computer.

41. A system as recited in claim 21, implemented on a digital computer, said computer having access to program code for implementing at least a portion of said system.

42. A system as recited in claim 21, wherin said signal generator is configured so as to produce a masking signal only when speech is present.

43. An article of manufacture comprising a computer usable medium having computer readable program code means embodied therein for causing a computer to:
generate an electrical signal representative of the speech:
use said electrical signal to provide an audio signal which cancels the speech; and
provide a speech masking signal to mask any speech not canceled.

44. An article of manufacture as recited in claim 43, further comprising program code for effecting a babble generator to supply said speech masking signal.

45. An article of manufacture as recited in claim 43, further comprising program code for producing said speech masking signal by rearranging the speech so that it is not intelligible.

46. An article of manufacture as recited in claim 43, further comprising program code for pitch inverting said speech to provide said speech masking signal.

47. An article of manufacture as recited in claim 46, wherein said program code for pitch inverting comprises code for performing the steps of:
low pass filtering the electrical signal representative of the speech to provide a low pass filtered signal;
mixing the low pass filtered signal with a carrier frequency to produce an output signal including the carrier frequency and two side bands; and
low pass filtering the output signal to produce the masking signal.

48. An article of manufacture as recited in claim 43, wherein said computer code for providing a speech masking signal comprises code for:
digital representations of signals disruptive to the understanding of speech; and for
converting the digital representations to said speech masking signal.

49. An article of manufacture as recited in claim 48, wherein said digital representations are in the form of one of pulse code modulation and adaptive pulse code modulation.

50. An article of manufacture as recited in claim 48, wherein said digital representations are representative of multiple persons speaking simultaneously.

51. An article of manufacture as recited in claim 43, further comprising program code for producing said speech masking signal by:
sampling portions of the speech; and
providing the portions in reverse order.

52. An article of manufacture as recited in claim 51, wherein the program code for producing the speech masking signal includes program code for changing at least one of amplitude and frequency of the masking signal, at intervals.

53. An article of manufacture as recited in claim 52, wherein said program code causes said intervals to be fixed, variable or random.

54. An article of manufacture as recited in claim 43, wherein the program code for producing the speech masking signal includes program code for producing said speech masking signal by:
sampling portions of the speech; and
providing the portions with a predetermined time delay.

55. An article of manufacture as recited in claim 54, wherein the program code for producing the speech masking signal includes program code for changing at least one of amplitude and frequency of the masking signal, at intervals.

56. An article of manufacture as recited in claim 55, wherein said program code causes said intervals to be fixed, variable or random.

57. An article of manufacture as recited in claim 43, wherein the program code for producing the speech masking signal includes program code for:
sampling portions of the speech; and
providing the portions in reverse order and with a predetermined time delay.

58. An article of manufacture as recited in claim 57, wherein the program code for producing the speech masking signal includes program code for changing at least one of amplitude and frequency of the masking signal, at intervals.

59. An article of manufacture as recited in claim 43, wherein the program code for producing the speech masking signal includes program code for:
sampling portions of the speech; and
providing the portions in a random manner.

60. An article of manufacture as recited in claim 59, wherein the program code is configured so that the portions are provided so as to be random relative to amplitude and frequency of the speech.

61. An article of manufacture as recited in claim 60, wherein the program code for producing the speech masking signal includes program code for changing at least one of amplitude and frequency of the masking signal, at intervals.

62. An article of manufacture as recited in claim 43, in combination with a computer for reading and executing said computer readable program code.
